(19) United States
(12) Patent Application Publication
(10) Pub. No.: US 2011/0203819 A1
(43) Pub. Date: Aug. 25, 2011

(54) Power tool and torque adjustment method for the same

(75) Inventors: Kim Y.C. Tsai, Taichung County (TW); Cheng-I Teng, Taichung County (TW); Chia-Chang Yeh, Taichung County (TW)

(73) Assignee: MOBILETRON ELECTRONICS CO., LTD., Taichung County (TW)

(21) Appl. No.: 12/662,547

(22) Filed: Apr. 22, 2010

(30) Foreign Application Priority Data
Feb. 23, 2010 (CN) 2010 1012 0011.5

(51) Int. Cl. B23Q 5/10; B25B 23/147

(52) U.S. Cl. 173/1; 173/181

(57) ABSTRACT

A power tool includes a detecting member mounted in an output end of a housing, and a to-be-detected member mounted in a driver. When the driver is assembled with the output end of the housing, the detecting member will detect the to-be-detected member and transmit a signal to a torque adjustment unit disposed in the housing so as to enable the torque adjustment unit to automatically adjust the torque applied to the driver to reach a predetermined value, thereby preventing damage to the driver.

### BACKGROUND OF THE INVENTION

1. Field of the Invention

The present invention relates generally to a power tool, and more specifically to a power tool that has a means for automatically adjusting the torque applied to a driver, and a torque adjustment method for the power tool.

2. Description of the Related Art

A conventional power tool is used to drill holes in a workpiece or secure screws on a workpiece through a driver actuated by a motor. The power tool can apply different torques to different types of drivers according to different operating requirements. For example, a drill bit requires a high torque to operate, and an impact bit needs a low torque to work. Therefore, the power tool is usually equipped with a torque adjustment unit for adjusting an output torque applied to the driver and allowing an operator to set the torque valve in light of the type of the driver.

However, the operator is easy to set a wrong torque value of the torque adjustment unit by his negligence, such as the torque adjustment unit is set to a high torque value during the operation of the impact bit, or the torque adjustment unit is set to a low torque value after the installation of the drill bit. In the situation of improper operation, the conventional power tool has drawbacks of inefficiency at work, damage to the driver, and reduction in the service life of the power tool.

### SUMMARY OF THE INVENTION

It is one objective of the present invention to provide a power tool, which can have a means to automatically adjust an optimal torque to a user-selected driver, thereby enhancing efficiency at work and preventing damage to the driver.

To achieve this objective of the present invention, the power tool comprises a housing, a torque adjustment unit disposed in the housing, a driver detachably coupled to an output end of the housing, and a sensor assembly having a to-be-detected member mounted in the driver, and a detecting member mounted in the output end of the housing and electrically connected to the torque adjustment unit.

When detecting the to-be-detected member, the detecting member will transmits a signal to the torque adjustment unit so as to apply a suitable torque to the driver, thereby preventing damage to the driver.

It is another objective of the present invention to provide a torque adjustment method of a power tool, which can prevent damage to the driver when the torque setting is wrong.

To achieve this objective of the present invention, the torque adjustment method comprises steps of assembling a driver with an output end of a housing of the power tool, and detecting whether the driver is equipped with a to-be-detected member by means of a detecting member mounted in the output end of the housing of the power tool, and employing the detecting member to transmit a signal to a torque adjustment unit disposed in the housing of the power tool when detecting the driver is equipped with the to-be-detected member such that the torque adjustment unit can automatically adjust a torque applied torque to reach a predetermined value, thereby preventing damage to the driver.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a lateral view of a power tool according to a preferred embodiment of the present invention;

FIG. 2 is lateral sectional view of the power tool according to the preferred embodiment of the present invention;

FIG. 3 is a flow chart, showing a torque adjustment method of the power tool according to the preferred embodiment of the present invention; and

FIG. 4 is similar to FIG. 2, showing the power tool according to the preferred embodiment of the present invention is equipped with another type of the driver.

### DETAILED DESCRIPTION OF THE INVENTION

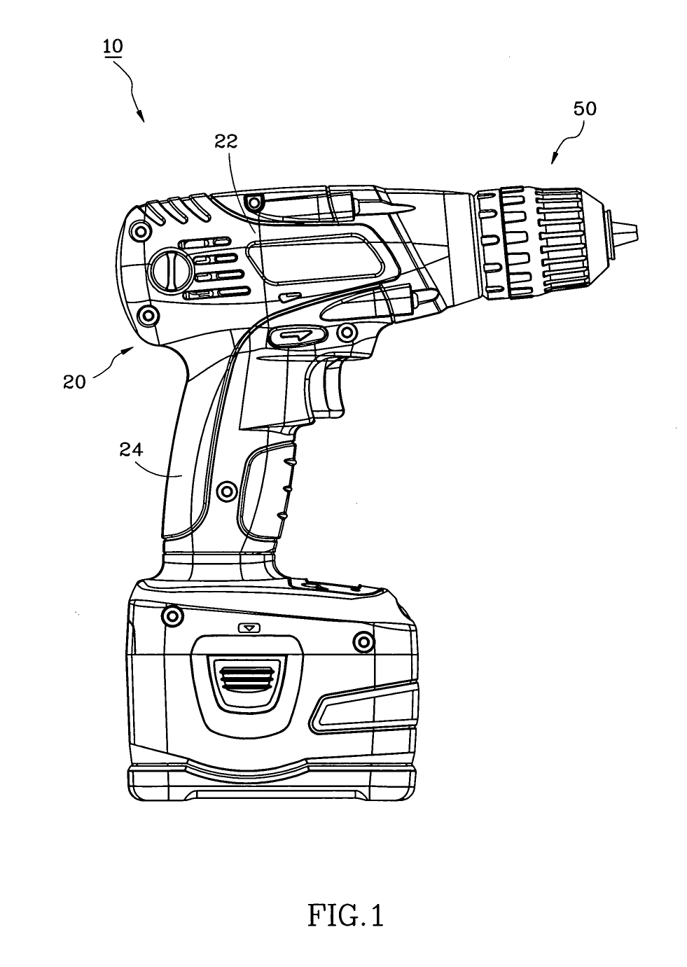

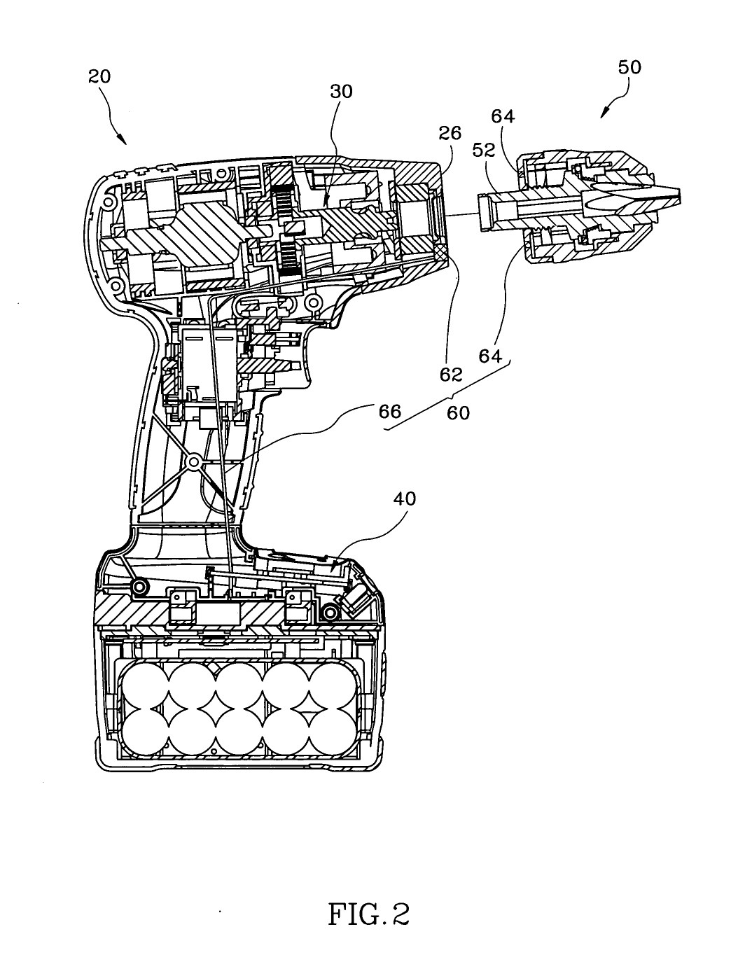

Referring to FIGS. 1 to 2, a power tool 10 in accordance with a preferred embodiment of the present invention comprises a housing 20, a driving unit 30, a torque adjustment unit 40, a driver 50, and a sensor assembly 60.

The housing 20 has a driving portion 22, a grip portion 24 extending downwards from the driving portion 22, and an output end 26 formed at the front end of the driving portion 22.

The driving unit 30 is installed in the driving portion 22 of the housing 20.

The torque adjustment unit 40 is disposed in the bottom of the grip portion 24 of the housing 20 for adjusting a torque produced by the driving unit 30.

The driver 50 has a shaft 52 inserted into the output end 26 of the housing 20 for connection with the driving unit 30 such that the driver 50 can be rotated by the actuation of the driving unit 30.

The sensor assembly 60 has a detecting member 62 embodied as a magnetic sensor, and two to-be-detected members 64 each embodied as a magnet. The detecting member 62 is mounted in the output end 26 of the housing 20, and electrically connected to the torque adjustment unit 40 through a wire 66. The to-be-detected members 64 are mounted in the driver 50 and respectively located at one side of the shaft 52 of the driver 50.

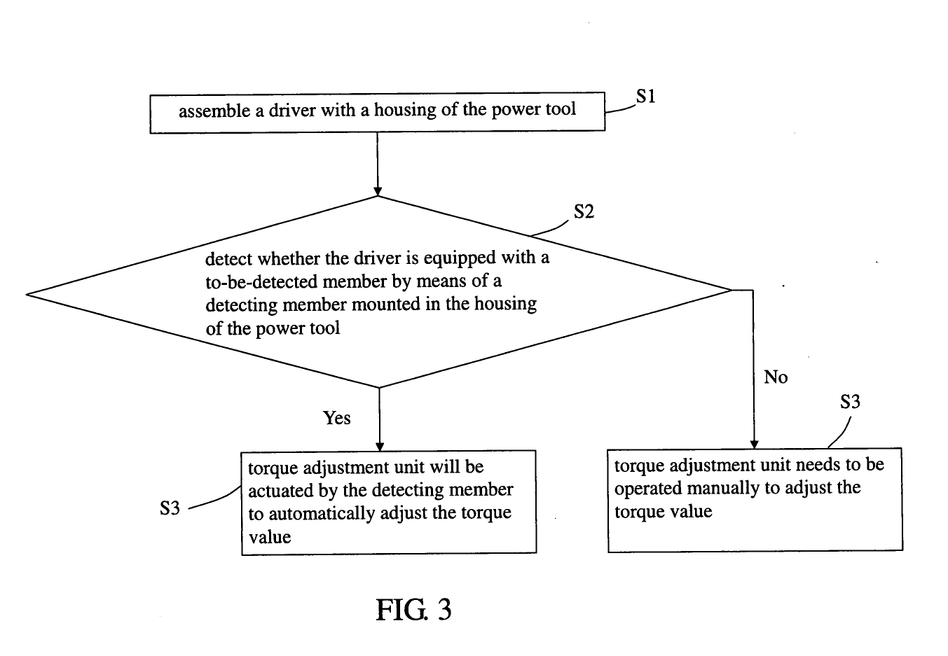

The structure of the power tool 10 is described as above, and the following is a torque adjustment method for the power tool 10, as shown in FIG. 3, including the steps S1 through S3.

The step S1 of the method is to assemble a driver 50 with the output end 26 of the housing 20 of the power tool 10 so as to allow the driver 50 to be rotated by the actuation of the driving unit 30.

The step S2 of the method is to detect whether the driver 50 is equipped with a to-be-detected member 64 by means of the detecting member 62 mounted in the output end 26 of the housing 20 of the power tool 10.

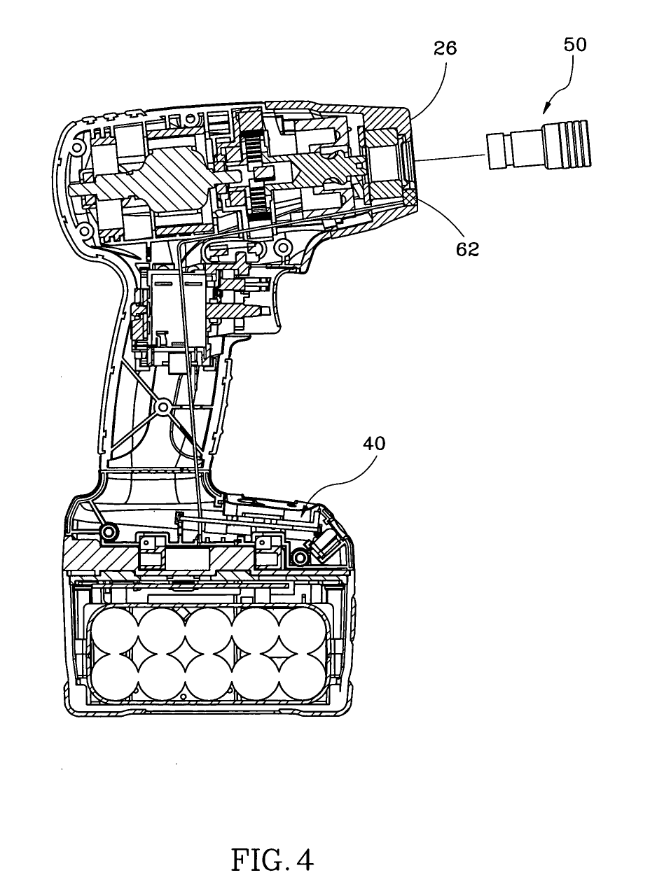

The step S3 of the method is to employ the detecting member 62 to transmit a signal to the torque adjustment unit 40 when detecting the driver 50 is equipped with the to-be-detected member 64, as shown in FIG. 2, such that the torque adjustment unit 40 can automatically adjust a torque applied to the driver 50 to reach a predetermined value for preventing damage to the driver 50. At this time, the torque adjustment unit 40 can't be operated manually. On the contrary, when the detecting member 62 detects the driver 50 isn't equipped with the to-be-detected member 64, as show in FIG. 4, the detecting member 62 won't transmit any signal to the torque adjustment unit 40, causing the torque adjustment unit 40 to be operated manually.

To deserve to be mentioned, different drivers 50 can be equipped with different to-be-detected members 64, and cooperated with different torque setting of the torque adjustment unit 64 such that the detecting member 62 can transmit different signals to the torque adjustment unit 40 by detecting different to-be-detected members 64 for allowing the torque adjustment unit 40 to adjust the torque to achieve different values.

Furthermore, the sensor assembly is not limited to the magnetic sensor as long as the sensor assembly employs a non-contact detection, such as RFID technique, a capacitive sensor or photoelectric sensor. If the sensor assembly uses RFID technique, the to-be-detected member is an RFID tag, storing the brand, type, and optimum torque value of the driver, and the detecting member is an RFID reader, reading data from the RFID tag.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A power tool comprising:
a housing having an output end;
a torque adjustment unit disposed in the housing;
a driver detachably coupled to the output end of the housing; and
a sensor assembly having a to-be-detected member mounted in the driver, and a detecting member mounted in the output end of the housing and electrically connected to the torque adjustment unit, wherein when the detecting member detects the to-be-detected member, the torque adjustment unit is actuated by the detecting member to adjust a torque applied to the driver.

2. The power tool as claimed in claim 1, wherein the detecting member is a magnetic sensor, and the to-be-detected member is a magnet.

3. The power tool as claimed in claim 1, wherein the to-be-detected member is two in number.

4. The power tool as claimed in claim 1, wherein the to-be-detected member is an RFID tag, and the detecting member is an RFID reader.

5. The power tool as claimed in claim 1, wherein the detecting member is a capacitive sensor.

6. The power tool as claimed in claim 1, wherein the detecting member is a photoelectric sensor.

7. A torque adjustment method for a power tool as claimed in claim 1, comprising the step of:
a) assembling a driver with an output end of a housing of the power tool;
b) detecting whether the driver is equipped with a to-be-detected member by means of a detecting member mounted in the output end of the housing of the power tool; and
c) employing the detecting member to transmit a signal to a torque adjustment unit disposed in the housing of the power tool when detecting the driver is equipped with the to-be-detected member such that the torque adjustment unit can automatically adjust the torque value.

8. The torque adjustment method as claimed in claim 7, wherein the detecting member transmits different signals to the torque adjustment unit by detecting different drivers so as to allow the torque adjustment unit to adjust different torque values.

9. The torque adjustment method as claimed in claim 7, wherein the torque adjustment unit can't be operated manually when the torque adjustment unit is in the control of the detecting member.
